(19) United States
(12) Patent Application Publication
(10) Pub. No.: US 2014/0265905 A1
(43) Pub. Date: Sep. 18, 2014

(54) Switchable Light Bulb Assembly with Integral Power Source

(71) Applicant: Brian Ray, Geneva, IL (US)

(72) Inventor: Brian Ray, Geneva, IL (US)

(21) Appl. No.: 14/210,075

(22) Filed: Mar. 13, 2014

Related U.S. Application Data
(60) Provisional application No. 61/786,283, filed on Mar. 14, 2013.

(51) Int. Cl. H05B 37/02

(52) U.S. Cl. CPC H05B 37/0245
USPC 315/210; 315/313

(57) ABSTRACT

A switchable light bulb assembly with integral power source is disclosed. The assembly has a light bulb, a power supply and a plug cap assembly. The plug cap assembly is configured to provide electrical communication between first and second electrical leads of a conventional light fixture. The light bulb is configured to be threadably insertable into a conventional, AC light fixture and provide electrical communication creating a circuit that can be opened or closed by operating the switch of the conventional light fixture. The power supply provides energy to the bulb when the circuit is closed.

### CROSS-REFERENCE TO RELATED APPLICATIONS

This application relates to and claims priority from U.S. Provisional Patent Application Ser. No. 61/786,283, filed Mar. 14, 2013.

### FIELD OF THE INVENTION

A switchable light bulb assembly with integral power source is disclosed. In a first preferred embodiment, the switchable light bulb assembly has an LED bulb and standard Edison threading, thereby fitting into a standard light bulb socket on an AC powerable lamp. The bulb has an internal battery as a source of power. Bulb switch contacts are positioned in the same place as those of an AC powered bulb and are configured to align with the circuit of the AC powerable lamp. The bulb comes equipped with a conductive plug cap for the AC plug on the lamp it will be installed in. Thus, the battery-powered bulb can be placed in a 110 volt lamp (unplugged) and the lamp on/off switch thus turns the bulb on and off.

In a second preferred embodiment, the switchable light bulb assembly with integral power source is completely electrically isolated from the light bulb socket in which it is installed. A pressure switch is located at the tip of the Edison threading section of the bulb. The pressure switch is engageable to turn the light bulb on when the light bulb is fully screwed into the light bulb socket.

Either embodiment can be equipped with a remote control switching device which turns the light bulb on and off when the light bulb is fully installed in the light bulb socket.

### BACKGROUND OF THE INVENTION

There is need for a switchable light bulb assembly with integral power source that can be installed in a conventional lamp base and used when conventional AC power is unavailable.

The following references illustrate the efforts of others to address the problems addressed by the present disclosure. As can be seen, there are a vast array of efforts already existing to provide a better light bulb, but none provides the combination of features and advantages presented in the instant disclosure.

These references include: U.S. Pat. No. 8,314,566 entitled “Solid State Lamp Using Light Emitting Strips,” issued to Steele et al. on Nov. 20, 2012; U.S. Pat. No. 8,299,712 entitled “Light Unit with Internal Power Failure Detection,” issued to Smith, III et al. on Oct. 30, 2012; U.S. Pat. No. 8,132,933 entitled “Power Blackout Bulb,” issued to Chao on Mar. 13, 2012; U.S. Pat. No. 8,115,397 entitled “Power Failure Reporting in a Networked Light,” issued to Jonsson on Feb. 14, 2012; U.S. Pat. No. 8,018,161 entitled “Light Unit with Internal Back-Up Power Supply, Communications and Display,” issued to Smith. Ill et al. on Sep. 13, 2011; U.S. Pat. No. 7,824,061 entitled “Rechargeable Battery Powered Cordless Lamps,” issued to Riedfort et al. on Nov. 2, 2010; U.S. Pat. No. 7,597,455 entitled “LED Light Bulb System,” issued to Smith, et al. on Oct. 6, 2009; U.S. Pat. No. 7,588,226 entitled “Mounting of Battery-Operated Bulb,” issued to Tuli on Sep. 15, 2009; U.S. Pat. No. 7,391,159 entitled “Lighting Device with Multiple Power Sources and Multiple Modes of Operation,” issued to Harwood on Jun. 24, 2008; U.S. Pat. No. 7,347,586 entitled “LED Light Bulb,” issued to Izardel on Mar. 25, 2008; U.S. Pat. No. 5,924,784 entitled “Microprocessor Based Simulated Electronic Flame,” issued to Chliwnyj et al, on Jul. 20, 1999; U.S. Pat. No. 5,655,830 entitled “Lighting Device,” issued to Ruskouski on Aug. 12, 1997; U.S. Pat. No. 5,136,477 entitled “Miniature Battery-Powered Lighting Device,” issued to Lemmey on Aug. 4, 1992; U.S. Pat. No. 4,918,357 entitled “Combination Incandescent and Solar-Electric Light Bulb with Automatic Switching Device and Charging Means Therefor,” issued to Waterbury on Apr. 17, 1990; U.S. Pat. No. 4,428,034 entitled “Light Bulb Mounting Unit,” issued to Seller on Jan. 24, 1984; U.S. Pat. No. 4,079,243 entitled “Battery Powered Lamp Assembly,” issued to Pemberton on Mar. 14, 1978; U.S. Pat. No. 3,757,107 entitled “Battery Powered Light Fixture,” issued to Peasley on Sep. 4, 1973; U.S. Pat. No. D583,495 entitled “Portable Light Bulb,” issued to Khubani on Dec. 23, 2008; U.S. Pat. No. D553,266 entitled “LED Light Bulb,” issued to Maxik on Oct. 16, 2007; U.S. Pat. No. D553,265 entitled “LED Light Bulb,” issued to Maxik on Oct. 16, 2007; U.S. Pat. No. D450,881 entitled “Battery Operated Lamp,” issued to Burke on Nov. 20, 2001; U.S. Pat. No. D310,729 entitled “Battery Powered Lamp,” issued to Stems on Sep. 18, 1990; U.S. Patent Application Publication No. 2013/0148342 entitled “Split Type LED Lamp,” published on behalf of Yang on Jun. 13, 2013; U.S. Patent Application Publication No. 2012/0320572 entitled “LED Lamp with Power Supply,” published on behalf of Fischer, et al. on Dec. 20, 2012; U.S. Patent Application Publication No. 2012/0293982 entitled “Battery Powered Lamp Socket that Supplies Energy for LED or CFL Light Bulbs,” published on behalf of Labans on Nov. 22, 2012; U.S. Patent Application Publication No. 2012/0126699 entitled “LED Light Bulb with Battery Backup and Remote Operation,” published on behalf of Zittel on May 24, 2012; U.S. Patent Application Publication No. 2011/0133649 entitled “Mechanisms for Light Management,” published on behalf of Kreiner et al. on Jun. 9, 2011; U.S. Patent Application Publication No. 2011/0089838 entitled “Heat Sinks and Lamp Incorporating Same,” published on behalf of Pickard et al. on Apr. 21, 2011; U.S. Patent Application Publication No. 2011/0075404 entitled “Battery Powered Indoor/Outdoor Decorative Table and Floor Lamp and LED Based Light Bulb,” published on behalf of Allen et al. on Mar. 31, 2011; U.S. Patent Application Publication No. 2010/0244735 entitled “Lighting Device Supplying Temporally Appropriate Light,” published on behalf of Buelow, II on Sep. 30, 2010; U.S. Patent Application Publication No. 2010/0244568 entitled “Lighting Module with Wireless Alternating Current Detection System,” published on behalf of Chandler et al. on Sep. 30, 2010; U.S. Patent Application Publication No. 2010/0097798 entitled “LED Light Module for Portable Lighting,” published on behalf of Young on Apr. 22, 2010; U.S. Patent Application Publication No. 2008/0304257 entitled “Lamp,” published on behalf of Opolka on Dec. 11, 2008; U.S. Patent Application Publication No. 2008/0252251 entitled “System for Recharging Battery-Operated Devices,” published on behalf of Joasil on Oct. 16, 2008; U.S. Patent Application Publication No. 2007/0258234 entitled “Decorative Wall Light Fixtures or Sconces Fed by an Electric Battery” and published on behalf of Shaw-Jones on Nov. 8, 2007; U.S. Patent Application Publication No. 2005/0174769 entitled “LED Light Bulb and Its Application in a Desk Lamp,” published on behalf of Yong et al. on Aug. 11, 2005: European Patent Application Publication No. EP 1876385 A2 entitled “Lamp and Bulb for Illumination and Ambiance Lighting,” published on behalf of S.C. Johnson & Son, Inc. on Jan. 9, 2008; WIPO Patent Application Publication No. WO 2010/111733 entitled “Self Powered LED Illuminator,” published on behalf of Groom, on Oct. 7, 2010; Webpage entitled “Rechargeable LED Emergency Bulb, 12 hrs Charging Time, 40V/0.8 mAh Lead-acid Battery, Supper(sic)Bright,”—Guangzhou-Kaaoer-Electronics-Co., —Ltd http://akled.manufacturer.globalsources.com/si/6008838564816/pdtl/LED-emergency/1047994268/LED-Emergency-Bulb.htm, downloaded Nov. 6, 2013; Webpage entitled “2013 Hot Sale LED Bulb Battery-Operated”; —http://www.alibaba.com/productgs/1058298424/2013_hot_sale_led_bulb_-battery.html, downloaded Nov. 6, 2013; and article entitled, “Magic Bulb's LED Bulb Features Rechargeable Battery, Ability to Become Flashlight,” Selleck; SlashGear, http://www.slashgear.com/magic-bulbs-led-bulb-features-rechargeable-battery-abilityto-become-flashlight-06100872/; Sep. 6, 2010, downloaded Nov. 6, 2013.

These references are discussed in greater detail as follows.

U.S. Pat. No. 8,314,566 generally discloses a solid state lamp, such as a lamp using LEDs and, in particular, a solid state lamp that requires relatively little cooling. In one embodiment, an LED lamp has a generally bulb shape. The LEDs are low power types and are encapsulated in thin, narrow, flexible strips. The LEDs are connected in series in the strips to drop a desired voltage. The strips are affixed to the outer surface of a bulb form to provide structure to the lamp. The strips are connected in parallel to a power supply, which may be housed in the lamp. Since many low power LEDs are used and are spread out over a large surface area, there is no need for a large metal heat sink. Further, the light emission is similar to that of an incandescent bulb. In another embodiment, there is no bulb form and the strips are bendable to have a variety of shapes. In another embodiment, a light sheet is bent to provide 360 degrees of light emission. Many other embodiments are described.

U.S. Pat. No. 8,299,712 generally discloses a light unit that includes an internal power supply that may be used in the event of an external power failure to provide power to the light unit. The disclosure provides a lighting apparatus, comprising (a) a power input configured to receive external power from an external power source; (b) a solid state light element that is interconnected to the power input; (c) a detection circuit interconnected to the power input and that, when power is not provided to the power input, measures input impedance at the power input and determines if there is a lack of external power; and (d) a back-up power source that is interconnected to the solid state light element and the power input and that provides power to the solid state light element when the light element is not provided with power from the power input.

U.S. Pat. No. 8,132,933 generally discloses a blackout light bulb having a housing with an Edison screw at one end for screwing into a light fixture socket and a plurality of spaced apart LEDs mounted to its opposite end. A flexible stalk is connected to the housing between the Edison screw and the LEDs and can be bent into a selected shape for positioning a free end of the stalk as desired. A circuit board in the housing has an electronic circuit connected to the Edison screw, to the LEDs and to a photo cell at the free end of the stalk. A rechargeable battery in the housing is connected to the circuit board so that it is charged under certain normal conditions and so that it lights up the LEDs under other blackout conditions.

U.S. Pat. No. 8,115,397 generally discloses a method for reporting a state of a networked light bulb. The method includes storing energy in a networked lighting apparatus and detecting that an external power source has been disconnected from the networked lighting apparatus. A network message is sent from the networked lighting apparatus in response to the detection that the external power source has been disconnected from the networked lighting apparatus, with the network message including data indicating that the networked lighting apparatus is turning off. The stored energy is sufficient to power at least a portion of the networked lighting apparatus for a period of time long enough to send the network message. A lighting device including an LED, a networked controller, power conversion circuitry, an energy storage device, and power detection circuitry may implement the method. Power is stored in a networked light allowing the networked light to send a message over the network providing information that the networked light is turning off if external power is no longer available.

U.S. Pat. No. 8,018,161 generally discloses a light unit that includes an internal power supply that may be used in the event of an external power failure to provide power to the light unit. The disclosure provides a lighting apparatus, comprising (a) a power input configured to receive external power from an external power source; (b) a solid state light element that is interconnected to the power input; and (c) a back-up power source that is interconnected to the solid state light element and the power input and that provides power to the solid state light element when the light element is not provided with power from the power input.

U.S. Pat. No. 7,824,061 generally discloses a cordless lamp utilizing a rechargeable battery in electrical communication with a light and a recharger for use therewith.

U.S. Pat. No. 7,597,455 generally discloses an LED light bulb having separately addressable groupings of LEDs. The LED light bulb can serve as a visual indicator of emergency or non-emergency conditions by selectively illuminating groupings of LEDs in a variety of colors, each color corresponding to a different condition.

U.S. Pat. No. 7,588,226 generally discloses a battery operated bulb projected onto a base urged into a pivotal transverse to be held in place to supplement ambient light at a site of use having minimal light.

U.S. Pat. No. 7,391,159 generally discloses a lighting device having a number of light sources for illuminating an area around the lighting device. The lighting device includes capabilities for generating illumination when a primary power source is unavailable. The light device may include a secondary power source for use in powering the lighting device when the primary power source is unavailable. The lighting device may include multiple operating modes, optionally depending on the active power source.

U.S. Pat. No. 7,347,586 generally discloses an LED light bulb including at least one LED mounted in a light bulb in electrical communication with an electrical contact adapted for connection to an electrical power source, and refractor/reflector positioned in the light bulb to reflect outwards light rays emanating from the at least one LED, the refractor/reflector including a curved surface concavely curved with respect to the at least one LED.

U.S. Pat. No. 5,924,784 generally discloses electronic lighting devices that simulate a realistic flame. The preferred embodiment has a plurality of lighting elements in a plurality of colors which are modulated in intensity by a control circuit with a stored program. The control program includes stored amplitude waveforms for the generation of a realistic flame simulation. The program further contains random elements to keep the flame constantly changing. The control circuit has built in power management functions that can control the mean intensity of the simulated flame based on a power management budget with the ability to measure the charge/discharge duration of the power source, when used with a rechargeable power source.

U.S. Pat. No. 5,655,830 generally discloses a long life, low maintenance and low energy consumption lighting device for connection with an electrical socket within the housing of an exit sign. The lighting device comprises a string of series connected LEDs connected in a circuit. The circuit comprises a capacitor for limiting the current flow through the LEDs and a resistor to limit the surge current through the LEDs. The resistor, capacitor and LEDs are connected to the socket by one of several different standard light bulb bases, and are housed within a hollow translucent or transparent tube connected to the base. A surge suppression device may be connected in parallel with the resistor, capacitor and LEDs to provide line transient protection for protecting the LEDs in response to transient voltage ic spikes. The lighting device may be provided with a pair of series connected LED strings connected in parallel with one another, the diodes in one string being connected in opposite polarity to the diodes in the other string. Additionally, the LEDs may be either discrete LEDs or die-on type LEDs mounted on one or both sides of a printed circuit board.

U.S. Pat. No. 5,136,477 generally discloses a miniature self-powered illuminating device including a thin-wall molded rectangular housing and removable bottom cover defining a battery compartment. The top surface of the housing includes a momentary on/off switch and an elongated flexible conduit mounted thereon. The conduit is economically formed using only protective coated dual-conductor stranded flexible wire tightly covered with a thin-wall plastic tube over its entire exposed length. By this arrangement, the molded reflector and sub-miniature high-intensity light bulb mounted therein may be easily manipulated into any desired shape. The housing is releasably attachable onto a working surface adjacent to or part of an object to be illuminated.

U.S. Pat. No. 4,918,357 generally discloses a dual-filament light bulb with associated adapter apparatus which uses photovoltaic cells mounted within the light bulb to charge a battery which powers one of the filaments. The adapter apparatus is designed to mount in an ordinary light socket which provides external current to the other filament. The adapter apparatus includes circuitry which alternately switches from the filament powered by the battery to the filament powered by external current in a manner which reduces the amount of electricity needed to produce a given amount of light.

U.S. Pat. No. 4,428,034 generally discloses a lamp comprising a battery housing, a lens body rotatably connected to a housing and a bulb holder unit which is rotatably fast with the lens body in the assembled lamp. The bulb holder unit is produced as a plastic molding and is provided with terminals which are so arranged that the lamp can be switched on and off by rotation of the lens body.

U.S. Pat. No. 4,079,243 generally discloses a light fixture of the type enclosing a plurality of standard dry cells. An outer, support member forms an outer housing to be affixed to a wall, ceiling or other fixed object. The outer housing receives an inner housing comprising a unitary battery enclosure, reflector and lamp socket receptacle. A sheet of resilient foam material disposed between the outer and inner housings is compressed upon assembly of the two members and urges them apart to aid in separating the members when the latches are released. A dome-shaped lens attaches to the inner housing to protect the lamp and to diffuse the light which it produces. The enclosures for the batteries which are formed by the inner housing are provided with partitions separating the batteries and upstanding bosses about certain of the contacts therefor, to prevent completion of an electrical circuit should any of the cells be reversed during installation.

U.S. Pat. No. 3,757,107 generally discloses a battery powered light fixture having a base adapted to be secured to a wall or other like support surface and a cover assembly overlying and removably attached to the base. The base is preferably plastic injection molded as one piece and has a centrally located bulb support; battery supports for locating pairs of batteries on opposite sides of the bulb support; an off-center switch support on which is mounted an “on-off” switch, a guide through which a pull chain for operating the switch extends beyond the periphery of the base. Metallic conductors, including clip-like members attached to the battery supports establish a series connection between the bulb, batteries and switch. The cover assembly includes an opaque wall, a concave reflector having an aperture therein through which the bulb protrudes, and a transparent dome overlying the reflector.

U.S. Pat. No. D583495 generally discloses an ornamental design for a portable light bulb.

U.S. Pat. No. D553,266 generally discloses an ornamental design for an LED light bulb.

U.S. Pat. No. D553,265 generally discloses an ornamental design for an LED light bulb.

U.S. Pat. No. D450,881 generally discloses an ornamental design for a battery operated lamp.

U.S. Pat. No. D310,729 generally discloses an ornamental design for a battery powered lamp.

U.S. Patent Application Publication No. 2013/0148342 generally discloses a split type LED lamp including a base and a lamp body. The lamp body has an LED light board, a second plug portion, a battery slot and a battery, and the LED light board has a plurality of LED light sources and a wireless signal receiver. The base and the lamp body may be combined and installed in a lamp holder for receiving electric power and used as a lamp bulb, or the lamp body may be removed and used as a flashlight independently. In addition, the battery can be replaced to reduce unnecessary waste of resources, and the wireless signal receiver is provided for receiving a wireless control signal transmitted from a remote controller or a mobile communication device to drive the lamp body to emit light and ic improve the convenience of use.

U.S. Patent Application Publication No. 2012/0320572 generally discloses a low voltage LED bulb having a base that fits a standard light socket designed to receive a bulb operated at line voltage. The bulb is installed in a conventional lamp, which is connected by a lamp cord to a rechargeable battery, the charge in which is maintained in a charging circuit. The rechargeable battery can be provided in a module equipped with a receptacle capable of receiving a standard plug designed for line voltage, and in this case the lamp requires no modification other than the replacement of the standard bulb by the low voltage LED bulb. In another embodiment, the battery and charger are incorporated into the lamp.

U.S. Patent Application Publication No. 2012/0293982 generally discloses a battery powered portable lamp socket that that supplies alternating current energy for standard thread low wattage alternating current LED or CFL light bulbs. The table lamp owner need only cut and remove the existing AC power cord and then unscrew the light bulb socket assembly from the table lamp and then install the disclosed battery powered lamp socket by screwing it back into the table lamp. The disclosed battery powered lamp socket also includes a DC to AC inverter circuit card.

U.S. Patent Application Publication No. 2012/0126699 generally discloses an LED lighting device for both general illumination and emergency backup lighting. The device has an outer bulb shell with air vents to release heat. A metal threaded base is adapted to fit into a standard incandescent bulb socket and to allow electricity to flow into the device. Housed within the outer bulb shell, and removably connecting the shell to the metal base is a lighting assembly. The lighting assembly is a cylindrical structure comprising bright LEDs arranged along outer surface, some of which are powered via wall outlet power from the metal base of the device, while others utilize an internal battery power source housed within the assembly. The battery powered LEDs may be remotely activated by a remote control means. Use of the remote control signal sends a signal to a receiving means on or within the device that directs the backup LEDs to illuminate.

U.S. Patent Application Publication No. 2011/0133649 generally discloses mechanisms for light management including an LED light bulb. The LED light bulb includes multiple LEDs configured for illumination in the LED light bulb and includes a battery. A base is configured to fit a standard socket designed for an incandescent light bulb, and the base is configured to operatively connect to an electrical power source. A module is operative to detect a residual voltage of the power source when a control for powering the LED light bulb is powered off. The module is configured to determine that a power outage occurred and operative to switch to battery power from the battery in response to not detecting the residual voltage of the power source.

U.S. Patent Application Publication No. 2011/0089838 generally discloses a lamp comprising a solid state light emitter, the lamp being an A-type lamp and providing a wall plug efficiency of at least 90 lumens per watt. Also disclosed is a lamp comprising a solid state light emitter and a power supply, the emitter being mounted on a heat dissipation element, the dissipation element being spaced from the power supply. Also disclosed is a lamp, comprising a solid state light emitter and a heat dissipation element that has a heat dissipation chamber, whereby an ambient medium can enter the chamber, pass through the chamber, and exit. Also disclosed is a lamp, comprising a light emissive housing, at least one solid state lighting emitter and a first heat dissipation element.

U.S. Patent Application Publication No. 2011/0075404 generally discloses a lamp configured for both indoor use and outdoor use. The lamp may include several features to protect against conditions encountered during outdoor use, such as wind, precipitation, lack of external power, etc. The lamp also defines an aesthetically pleasing design to provide lighting during upscale events and celebrations, such as weddings, reunions, holiday events, or a private gathering in a backyard. The functional and aesthetic features of the lamp, such as the lamp's capability of operating independently of a power cord, while at the same time defining a stylish appearance, may additionally make the lamp desirable for use in indoor environments.

U.S. Patent Application Publication No. 2010/0244735 generally discloses a lighting device operable to supply temporally appropriate light to a user. The lighting device comprises a light socket adapter interposed between a primary socket and a first type of lamp. The primary socket is connected to a switchable supply of electrical power. A first type of lamp includes wavelengths below 530 nm that are suppressive of melatonin production in a user viewing the light. There is a second type of lamp located in the light socket adaptor that supplies light substantially all above 530 nm so as to avoid suppressing melatonin production in a user viewing the light. The light socket adapter has at least one mode of operation in which automatic means causes the first and second types of lamp to be exclusively operable during respective predetermined periods of time.

U.S. Patent Application Publication No. 2010/0244568 generally discloses a lighting module with a wireless alternating current (AC) detection system. The lighting module comprises an LED, an antenna configured to receive electromagnetic radiation (EMR), a resonant circuit coupled to the antenna and configured to detect the presence of AC power in an electrical network having a segment close to the lighting apparatus. The detection of the AC power is based at least in part on EMR of a predetermined frequency being received by the antenna. The lighting module further comprises a controller coupled to the resonant circuit and the LED, and configured to control the LED based at least in part on a success or failure of detection of the AC current by the resonant circuit coupled to the antenna.

U.S. Patent Application Publication No. 2010/0097798 generally discloses an LED light module for portable lighting which comprises a supporting base, a supporting plate, a diffusing cover, an electrical base, an axle, four round flat top single die miniature LEDs each with a light emitting angle of 100 degrees and a driving circuit disposed inside the axle and electrically connected to the LEDs.

U.S. Patent Application Publication No. 2008/0304257 generally discloses a lamp having a light source, a holder for accommodating a battery and means for providing a closed circuit, wherein the holder comprises a plastic body which has a fastening means, preferably a drilled hole or a pin element for connecting a lamp head, also at least one drilled hole for fixing an arm in a friction-locking or interlocking manner with an end-side fastening and two exposed contacts, which can be connected detachably to the contacts of a single battery.

U.S. Patent Application Publication No. 2008/0252251 generally discloses a system for charging rechargeable devices. The system includes a base, wherein the base further includes: a plurality of power sources; at least one rechargeable battery in electrical communication with the plurality of power sources; and a plurality of recharging ports in electrical communication with the at least one rechargeable battery. The system also includes at least one rechargeable device, wherein the at least one rechargeable device is adapted to be compatible with at least one of the plurality of recharging ports, and wherein the at least one rechargeable battery in the base provides energy sufficient to charge the at least one rechargeable device.

U.S. Patent Application Publication No. 2007/0258234 generally discloses decorative wall fixtures or sconces which include a two part structure. The two part structure includes a front plate, which is a hollow, generally translucent bowl that has pegs mounted on the inside upper edge, and a back plate that has notches on its upper edge. The notches in the back plate hold the translucent bowl, and the back plate also holds a single cell or multi-cell battery, a light bulb and a switch means provided for switching the light bulb on and off.

U.S. Patent Application Publication No. 2005/0174769 generally discloses an LED light bulb which includes a screw base, a shell formed by two halves of hemispherical shells connecting tightly in the middle and a number of LEDs distributed spherically symmetrically on a curved flexible printed circuit board inside an inner front of the shell. The LEDs are series or parallel connected and arranged, when working, to emit light evenly in all directions. The LED light bulb can be used in a desk lamp.

European Patent Application Publication No. EP 1876385 A2 generally discloses a lighting device comprising an illumination source emitting illumination light when supplied with electrical power; a plurality of LEDs emitting light when supplied with electrical power; a base supporting the LEDs; circuitry connecting a supply of electrical power to the illumination source and the LEDs, the circuitry causing the illumination source to emit illuminating light and causing the LEDs to emit colored or white light.

WIPO Patent Application Publication No. WO 2010/111733 generally discloses an illuminator having the general form of a conventional electric globe, which can be fitted into the socket of a conventional lamp fitting and then switched on such that the appearance is that of a mains powered lamp although the power source is contained entirely within the illuminator fitted into the socket. The illuminator comprises: (a) a shell having: a tail portion either adapted to fit into a conventional Edison-screw or bayonet-connection type lamp fitting, and a transparent or translucent head portion extending from the tail portion; (b) an LED light source and an electric battery power source housed within said shell; and (c) a manually actuate-able switch connecting the LED light source to the battery. The tail portion has no electrically conductive components on its outside surface such that said illuminator is incapable of receiving electric power from said lamp fitting.

Webpage entitled “Rechargeable LED Emergency Bulb, 12 hrs Charging Time, 40V/0.8 mAh Lead-acid Battery, Supper(sic)-Bright”-Guangzhou-Kaaoer-Electronics-Co., —Ltd., http://akled.manufacturer.globalsources.com/si/6008838564816/pdtl/LED-emergency/1047994268/LED-Emergency-Bulb.htm generally discloses an emergency LED bulb with a rechargeable battery. The bulb has an external switch to switch from DC to AC. The bulb has an internal battery that is charged with AC power. When the external switch is on DC the bulb is lit with the battery. When the external switch is on AC, the internal battery is charged.

Webpage entitled “2013 Hot Sale LED Bulb Battery-Operated”; —http://www.alibaba.com/productgs/1058298424/2013_hot_sale_led_bulb_battery.html generally discloses an LED bulb operable at 90-264 volts AC.

Article entitled, “Magic Bulb's LED Bulb Features Rechargeable Battery, Ability to Become Flashlight,” Selleck; SlashGear, http://www.slashgear.com/magic-bulbs-led-bulb-features-rechargeable battery-abilityto-become-flashlight-06100872/; Sep. 6, 2010 generally discloses an LED bulb that has a rechargeable battery inside. The bulb can be used as a conventional LED light bulb. The bulb can be unscrewed from its housing, and used as a handheld flashlight by extending the neck.

Thus, a problem associated with devices that precede the present disclosure is that they do not provide, in combination with the other features and advantages disclosed herein, a light bulb assembly having an integral power source that can be installed in a conventional, Edison threaded lamp fixture and turned on and off with the existing switch on the lamp fixture.

Still a further problem associated with devices that precede the present disclosure is that they do not provide, in combination with the other features and advantages disclosed herein, a light bulb assembly having an integral power source that can be operated remotely when installed in a conventional, Edison threaded lamp fixture.

There is a demand, therefore, to overcome the foregoing problems while at the same time providing a light bulb assembly having an integral power source that can be installed in a conventional. Edison threaded lamp fixture and turned on and off with the existing switch on the lamp fixture when conventional, AC power is lost to the lamp fixture.

### SUMMARY OF THE INVENTION

It is an object of the present disclosure is to provide, in combination with the other features and advantages disclosed herein, a light bulb assembly having an integral power source that can be installed in a conventional, Edison threaded lamp fixture and turned on and off with the existing switch on the lamp fixture.

An additional object of the present disclosure is to provide, in combination with the other features and advantages disclosed herein, a light bulb assembly having an integral power source that can be operated remotely when installed in a conventional, Edison threaded lamp fixture.

The following disclosure provides a light bulb assembly with integral source of power that provides the foregoing advantages while at the same time is convenient and safe to use, while being durable and relatively inexpensive to manufacture.

### BRIEF DESCRIPTION OF THE DRAWINGS

In the detailed description that follows, reference will be made to the following figures:

FIG. 1 is a perspective, cross-sectional view first embodiment of the disclosure;

FIG. 2 is a cutaway view of a portion of the embodiment shown in FIG. 1;

FIG. 3 is a top plan view of a portion of the embodiment shown in FIGS. 1 and 2;

FIG. 4 is a simplified circuit diagram showing operative features of the embodiment shown in FIG. 1; and

FIG. 5 is a cutaway view of a portion of a second embodiment of the disclosure.

### DETAILED DESCRIPTION OF PREFERRED EMBODIMENTS

A switchable light bulb assembly with integral power source is disclosed. The disclosed bulb is configured to be installable in a conventional light fixture in the event that conventional, AC power is not available. In a first embodiment, a plug cap is optionally provided to be placed over the power plug of the conventional light fixture, thereby insulating the light from unintentional access to AC current and further completing the circuit in the conventional light so that the light switch is the only point at which the circuit can be opened or closed. In a second embodiment, the bulb is not in electrical communication with the light switch of the conventional light fixture, and is rather turned on and off with a remote control.

In the preferred embodiments, the bulb is an LED bulb and the integral power source is an internal DC battery. However, it is understood that the bulb need not be an LED: the LED was selected to minimize current draw, thereby extending maximum operation time of the light. Additionally, it is understood that the integral power source need not be internal and need not be a battery. A solar panel may be employable, either alone or in combination with a battery. Where a battery is used, the battery may be rechargeable or disposable.

Referring in more detail to the first preferred embodiment, the existing on/off switch in the lamp fixture is used to turn the LED light bulb on and off. To use the disclosed LED light bulb with an internal battery in a light fixture, the user would unplug the lamp fixture, replace the conventional light bulb with the disclosed LED light bulb with an internal battery and cap the lamp fixture plug with a plug cap. The plug cap is designed to electrically connect the lamp plug prongs, completing the circuit so that the lamp on/off switch can operate the LED light bulb with an internal battery. Further, the plug cap electrically insulates the exterior of the plug, ensuring safety.

FIG. 1 shows a perspective, partial cross-sectional view of an LED bulb with an internal battery, 100, as well as a plug cap 200 and a lamp fixture socket 300. The LED bulb with internal battery 100 has a shell 12, a base 14 and a collar 16, which is constructed and arranged to connect the shell 12 and the base 14. The shell 12 is hollow and comprised of a suitable translucent material, such as plastic. The collar 16 is annular and constructed and arranged to connect the shell 12 and the base 14. The base 14 is generally cylindrical (with perhaps a slight taper). The base is hollow and constructed and arranged to be threadable into a standard Edison socket. The base 14 has electrically conductive exterior threading 18. On the bottom of the base 14 is a nipple 22. The nipple 22 is electrically conductive, but is electrically insulated from the exterior threading 18.

The light fixture socket 300 is generally cylindrical and hollow and is constructed and arranged to threadably accept the base 14. Shown schematically in the interior of the light fixture socket 300 are thread contact 24 and nipple contact 26. The thread contact 24 and nipple contact 26 are electrically conductive and are constructed and arranged to make electrical contact with respectively, electrically conductive exterior threading 18 and electrically conductive nipple 22 on the base 14. The thread contact 24 and nipple contact 26 are also in electrical contact, via lamp cord wires 28 with prongs 32 of plug 34. Plug 34 is a conventional electrical plug, suitable to be plugged into a 110 volt household electricity supply. A lamp switch 36 is also part of the light fixture socket 300. The lamp switch 36 is constructed and arranged to complete or open an electrical connection between the thread contact 24 and the nipple contact 26 to turn the light on or off.

The plug cap 200 is also shown schematically in FIG. 1. The plug cap is arranged so that it has cavities 38 that are shaped to accept prongs 32. The cavities 38 are electrically conductive and are in electrical communication with each other via a wire 42 or other convenient means. The plug cap also has an electrically insulated exterior 44. The plug cap 200 must be installed on the prongs 32 so that the lamp switch 36 can operate the LED bulb with internal battery 100. Alternatively, it is understood that a plug cap assembly could be fashioned without actually putting a cap over the ends of the plug prongs. In this way, all that has to be accomplished is to provide electrical communication between first and second electrical leads of a conventional light fixture—in other words, ensure that the positive and negative wires extending toward the plug are rendered in electrical communication. This could be accomplished by baring the lead wires and twisting them together at a joining locus, preferably covered by a cap for safety and integrity.

As shown in FIG. 2, a cutaway view is shown. In the interior of LED bulb 100 is a battery 46. The battery 46 may be of any type, disposable or rechargeable. Further, while only one battery 46 is shown, for simplicity, it is understood that a plurality of batteries 46 may be used and that the battery 46 or batteries 46 may also be enclosed in a holder (not shown), for convenience of replacement. The battery or batteries 46 can produce up to 4.5 volts of direct current, in total.

Also shown in the interior of LED bulb 100 is thread wire 48. The thread wire 48 is arranged to electrically connect the conductive exterior threads 18 to the battery 46. Leading from the nipple 22 to an LED printed circuit board (PCB) 52 is a nipple wire 54. The nipple wire 54 is arranged to electrically connect the nipple 22 to the LED PCB 52.

As shown more clearly in FIG. 3, the LED PCB 52 is triangular, and supports an LED support 56. The LED support 56 is a three-sided pyramid, as can be seen in side view in FIG. 2 and top view in FIG. 3. Mounted in each of the three sides of LED support 56 is an LED 58, These LEDs 58 are in electrical communication with the LED PCB 52, such that LED PCB 52 supplies the LEDs 58 with power according to instructions programmed into the LED PCB 52.

The three LEDs 58 are each further shaped like a funnel, with a sharp point mounted towards the LED support 56 and having flat tops pointing outwards. The sides of LED support 56 are sloped at an angle of between 30 and 45 degrees from horizontal to maximize the light dispersion of LEDs 58. Shown in FIG. 2 on top of the LED support 56 is a rigid member 60 (FIG. 2) that is constructed and arranged to be fixedly attached to the top of the LED support 56 and the interior of the shell 12. The rigid member 60 will support and secure the LED support 56 to protect it from dropping or vibration.

The LED PCB 52 is programmed to multiplex the LEDs 58 such that only one of the three LEDs 58 is on at a time, in order to maximize battery life. To maximize LED brightness, the PCB 52 uses PWM (Pulse Width Modulation) to keep the voltage and current regulated to the LEDs 58 as much as possible. As the battery 46 voltage decreases from use, the PCB 52 will change the PWM to regulate and maintain as much as possible, ideal operational voltage of LEDs 58, to keep brightness as high as possible, for a long as possible. Further, the LED PCB 52 incorporates an automatic switch bridge in the battery power circuit. This automatic switch bridge will permit the battery or batteries 46 to be installed in any polarity. The automatic switch bridge can direct positive power always to a positive circuit and the negative power always to a negative circuit in order to protect the circuitry and maximize battery life. The automatic switch bridge is comprised of germanium diodes or any other semiconductor that has the least forward conduction loss, to maintain battery life.

FIG. 4 is a simplified electrical schematic showing how the lamp switch 36 can turn on and off the LEDs 58. The thread contact 24 in the socket 300 connects with the electrically conductive threads 18 on the LED light bulb (100, as shown in FIG. 1) and the nipple contact 26 in the socket (300, as shown in FIG. 1) connects with the conductive nipple 22 on the LED light bulb (100, as shown in FIG. 1). The rest of the circuit is comprised of the thread wires 48 (leading from the thread contacts 18) connecting to battery 46 which is connected to LED PCB 52. LED PCB 52 powers and controls LEDS 58 which are connected to nipple 22 via nipple wire 54. The nipple 22 contacts nipple contact 26 (located in socket 300). The nipple contact 26 is connected to the lamp switch 36. The lamp switch 36 is connected to one of the prongs 32. The other of prongs 32 is connected the thread contact 24. Because the prongs 32 are connected together with the plug cap wire 42, opening and closing the lamp switch 36 will turn on or off the LED bulb (100, as shown in FIG. 1).

A second preferred embodiment of the LED light bulb with an internal battery is also designed to be installed in a conventional lamp fixture, but is completely electrically insulated from the lamp fixture. This embodiment has a pressure switch located at the tip of the threaded base which will turn on the LED light bulb with an internal battery only when it is completely installed in the lamp fixture. This second embodiment not only does not use the lamp fixture switch to turn it on and off, but also does not need to have the conductive plug installed on the lamp plug to complete the electrical circuit. This second embodiment also has a remote control device to turn it on and off when the LED bulb is completely installed in the lamp fixture.

FIG. 5 is a cutaway cross section of a second preferred embodiment of an LED light bulb with an internal battery 400. This second embodiment comprises the same translucent shell 18 and collar 16 as the first embodiment 100, but has an electrically insulated base 62. The electrically insulated base 62 is comprised of a suitable electrically insulating material such as plastic, e.g. nylon and is molded to threadably fit into a standard Edison electric light bulb socket. The electrically insulated base 62 has a bottom 64.

Again, like the first preferred embodiment 100, this second preferred embodiment LED light bulb 400 is hollow and designed to hold the battery or batteries 46. The battery 46 powers an LED PCB (printed circuit board) 68 via a battery wire 68.

The battery wire 68 is connected to a pressure switch 72. The pressure switch 72 is not electrically conductive and may be comprised of a suitable electrically insulating material such as plastic, e.g. nylon. The pressure switch 72 protrudes through the bottom 64 of the electrically insulated base 62 and has a top end 74 and a bottom end 76.

The pressure switch 72 can move up and down vertically with respect to the insulated base 62. The battery wire 68 is fixed to the top end of the switch 72. When the LED bulb 400 is fully installed in a socket, the bottom end 76 is pushed upward into the base 62 so that the battery wire 68 fixed to the top end 74 makes contact with the battery 46, thus completing the circuit and powering the LED PCB 66.

The LED PCB 66, like the LED PCB 52 of the first embodiment 100, is triangular and supports the same pyramid shaped LED support 56 containing funnel-shaped LEDs 58 as are used in the first embodiment.

Also like the first embodiment 100, attached to the top of the LED support 56 is a rigid member 60 that is constructed and arranged to be fixedly attached to the top of the LED support 56 and the interior of the shell 12. The rigid member 60 will support and secure the LED support 56 to protect it from dropping or vibration.

The LED PCB 66 of this second embodiment LED light bulb 400 is programmed slightly differently than the LED PCB 52 in the first LED light bulb embodiment 100.

The LED PCB 66, in addition to being programmed with all the same functionality as described above for the LED PCB 52, the LED PCB 66 incorporates a high impedance sleep circuit that can monitor for incoming ultrasonic sound function information in regular cycles. This sleep circuit draws power in the picoamp range. The ultrasonic sound function can signal the LED PCB 66 to turn on or off the LEDs 58 and is capable of detecting sound above 20 Khz frequency.

The ultrasonic sound to signal the LED PCB 66 to turn on or off the LEDs 58 is produced by a mechanical remote control unit 78 such as, for example, that described in U.S. Pat. No. 2,821,954.

As thus described, a switchable light bulb assembly with integral power source is disclosed. A first embodiment of the LED light bulb system with an internal power source comprises a base, a translucent shell, at least one LED, a printed circuit board, a power source and an electrically conductive plug cap. The base and the translucent shell together have an internal cavity which contains the power source, the printed circuit board and the at least one LED. The base is configured to be threadably secured in a standard Edison light fixture socket.

It is understood that a standard Edison light fixture socket comprises a thread contact, a nipple contact, and a plug and that the plug has two prongs. One of the prongs is in electrical communication with the thread contact and the other of the prongs is in electrical communication with the nipple contact. The thread contact and the nipple contact are both in electrical communication with a switch that can open and close an electrical circuit between the thread contact and the nipple contact.

In this first embodiment, the power source is in electrical communication with the printed circuit board and the printed circuit board is in electrical communication with the at least one LED. The printed circuit board is programmed to control and power the at least one LED.

Also in this first embodiment, the base has an electrically conductive exterior threading and an electrically conductive nipple, and the electrically conductive exterior threading and the electrically conductive nipple are electrically insulated from each other. The electrically conductive exterior threading is in electrical contact with the power source, and the electrically conductive nipple is in electrical communication with the at least one LED.

Because the electrically conductive exterior threading on the base in this first embodiment is arranged to make electrical contact with the thread contact in the socket and the electrically conductive nipple is arranged to make electrical contact with the nipple contact in the socket, the lamp switch can turn the LEDs on and off when the electrically conductive plug cap placed the two prongs of the lamp plug closes the circuit between the two prongs.

A second embodiment of the LED light bulb system comprises a base, a translucent shell, a power source, a printed circuit board, at least one LED, and a remote control.

The base and the translucent shell together have an internal cavity, containing the power source, the printed circuit board and the at least one LED. The power source is in electrical communication with the printed circuit board and the printed circuit board is in electrical communication with the at least one LED. The printed circuit board is programmed to control and power the at least one LED.

The base of this second embodiment is electrically insulated and configured to be threadably secured in a standard Edison light fixture socket and the base has a switch configured to complete an electrical circuit between the power source and the printed circuit board when the base is secured in the standard Edison light fixture socket, thereby powering the printed circuit board with the power source so that the printed circuit board powers and controls the at least one LED.

The printed circuit board in this second embodiment is programmed receive a signal from the remote control to turn the at least one LED on or off when the base is fully installed in the Edison socket.

The described embodiments are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

I claim:

1. A switchable light bulb assembly with integral power source comprising:
a light bulb, a power supply and a plug cap assembly;
the light bulb having a light-generating component configured to convert electrical energy to light and a base configured to be threadably insertable into a conventional, AC light fixture;
the light-generating component having a first electric-current conducting connection and a second electric-current conducting connection, whereby electric-current is conductable to the first electrical conducting connection, through the light-generating component and from the second electrical conducting connection, thereby providing electrical energy to the light-generating component;
the base having a generally cylindrical side wall having conductive, exterior threading outwardly disposed in threaded relation along the cylindrical side wall, and a bottom terminus region having a conductive nipple disposed thereon, the conductive threading and the conductive nipple being electrically isolated from one another;
the threading configured to be in electrical communication with the first electric-current conducting connection;
the conductive nipple configured to be in electrical communication with the second electric-current conducting connection;
the power supply constructed and arranged to supply electric-current to the light-generating component when a circuit is closed;
the plug cap assembly configured to provide electrical communication between first and second electrical leads of a conventional light fixture;
the light fixture further having a light fixture socket having a thread contact and a nipple contact each being in electrical communication with an ON-OFF switch that can open and close an electrical circuit therebetween;
the thread contact being in electrical communication with the first electrical lead and also being positionable to be in electrical communication with the conductive, exterior threading of the light bulb by positioning the light bulb securely in the light bulb socket;
the nipple contact being in electrical communication with the second electrical lead and also being positionable to be in electrical communication with the conductive nipple of the light bulb by positioning the light bulb securely in the light bulb socket; and
whereby the switch opens (OFF) or closes (ON) the circuit, thereby selectively powering the light-generating component and generating light.

2. The switchable light bulb assembly with integral power source of claim 1, wherein the light-generating component further comprises an LED light system having a printed circuit board and an LED.

3. The switchable light bulb assembly with integral power source of claim 2, wherein the LED light system comprises three LEDs.

4. The switchable light bulb assembly with integral power source of claim 3, further comprising:
an LED support mounted on the printed circuit board, the LED support comprising a pyramid having three identical sides sloped at an angle of between 30 and 45 degrees from horizontal; and
each of the three sides of the LED support having one LED positioned thereon.

5. The switchable light bulb assembly with integral power source of claim 1 wherein the power source comprises a battery.

6. The switchable light bulb assembly with integral power source of claim 5 wherein the battery is rechargeable.

7. The switchable light bulb assembly with integral power source of claim 3 wherein the printed circuit board is programmed to multiplex the three LEDs, whereby only one of the three LEDs is on at a time.

8. The switchable light bulb assembly with integral power source of claim 2 wherein the printed circuit uses Pulse Width Modulation to regulate the operational voltage of the LED.

9. The switchable light bulb assembly with integral power source of claim 2 wherein the printed circuit board comprises an automatic switch bridge.

10. The switchable light bulb assembly with integral power source of claim 9 wherein the automatic switch bridge is comprised of germanium diodes.

11. An LED light bulb system comprising, in combination:
a base and a translucent shell defining an internal cavity constructed and arranged to receive a power source, a printed circuit board and an LED;
the power source being in electrical communication with the printed circuit board, the printed circuit board being in electrical communication with the LED, and the printed circuit board being programmed to control and power the LED;
the base being electrically insulated and constructed and arranged to be threadably securable in a standard Edison light fixture socket;
an ON-OFF switch constructed and arranged to complete an electrical circuit between the power source and the printed circuit board when the base is secured in the standard Edison light fixture socket;
whereby when the switch is ON, the printed circuit board receives power from the power source and powers and controls the LED.

12. The LED light bulb system of claim 11, further having a remote control to operate the switch, the switch further being incorporated into the printed circuit board and configured to receive a signal from the remote control to turn the LED on or off.

13. The LED light bulb system of claim 12 wherein the remote control emits an ultrasonic frequency to signal the printed circuit board to turn the LED on or off.

14. The LED light bulb system of claim 13 wherein the ultrasonic frequency is above 20 kHz.

15. The LED light bulb system of claim 13, wherein the LED light bulb system comprises three LEDs.

16. The LED light bulb system of claim 15, further comprising:
an LED support mounted on the printed circuit board, the LED support comprising a pyramid having three identical sides sloped at an angle of between 30 and 45 degrees from horizontal; and
each of the three sides of the LED support having one LED positioned thereon.

17. The LED light bulb system of claim 16 wherein the power source comprises a battery.

18. The LED light bulb system of claim 17 wherein the battery is rechargeable.

19. The LED light bulb system of claim 16 wherein the printed circuit board is programmed to multiplex the three LEDs, whereby only one of the three LEDs is on at a time.

20. The LED light bulb system of claim 19 wherein the printed circuit uses Pulse Width Modulation to regulate the operational voltage of the LED.
